(19) United States
(12) Patent Application Publication
(10) Pub. No.: US 2011/0320193 A1
(43) Pub. Date: Dec. 29, 2011

(54) SPEECH ENCODING DEVICE, SPEECH DECODING DEVICE, SPEECH ENCODING METHOD, AND SPEECH DECODING METHOD

(75) Inventors: Toshiyuki Morii, Kanagawa (JP); Hiroyuki Ehara, Kanagawa (JP)

(73) Assignee: PANASONIC CORPORATION, OSAKA (JP)

(21) Appl. No.: 13/255,810

(22) PCT Filed: Mar. 12, 2010
(86) PCT No.: PCT/JP2010/001792

§ 371 Date: Sep. 9, 2011

(30) Foreign Application Priority Data
Mar. 13, 2009 (JP) 2009-060791

(51) Int. Cl. G10L 19/00

(52) U.S. Cl. 704/201; 704/E19.001

(57) ABSTRACT

Provided is a speech encoding device that is capable of performing encoding in an extension encoder even when the core encoder and core decoder of each layer have been interchanged, and that is also capable of performing high precision encoding by using the appropriate codec for each situation. The speech encoding device (100) performs hierarchical encoding of a speech signal by using the information of a lower layer in a higher layer. A core encoder (102) in the speech encoding device (100) generates a code by encoding the speech signal. A core decoder (104) generates a decoded signal by decoding the code generated by the core encoder (102). An adding unit (106) detects the encoding residual between the speech signal and the decoded signal generated by the core decoder (104). An auxiliary analyzing unit (107) inputs the decoded signal and generates lower layer information by conducting analysis processing and adjustment processing. An extension encoder (108) encodes the encoding residual using the speech signal and the lower layer information.

### TECHNICAL FIELD

The present invention relates to a speech encoding apparatus, a speech decoding apparatus, a speech encoding method, and a speech decoding method.

### BACKGROUND ART

In mobile communication, is necessary to compress and encode digital information of speech or images to use a transmission band efficiently. In particular, expectation for a speech codec (encoding and decoding) technique, which is widely used for mobile phones, is large, and demand for better sound quality for a conventional high-efficient encoding with a high compression rate has been increased.

In recent years, the scalable codec having a multi-layer structure is used for the Internet protocol (IP) communication network as more efficient and higher-quality speech codec, and the standardization is under consideration by International Telecommunication Union—Telecommunication Standardization Sector (ITU-T) or Moving Picture Experts Group (MPEG).

A speech and sound encoding technique has made significant progress thanks to the speech encoding technique that has improved performance considerably by the code excited linear prediction (CELP), which is a fundamental scheme that applies vector quantization by modeling a vocal tract system of speech, which was established 20 years ago, and thanks to transform coding techniques (for example, MPEG-standard AAC (Advanced Audio Coding) and MP3) that have been used for audio encoding, making it possible to perform communication and listen music in a high quality manner. Further, in recent years, to aim for full IP, seamless, or broadband communication, development and standardization (ITU-T SG 16 WP3) of a scalable codec covering from speech to audio is underway. These codecs cover frequency bands in a layered manner and encode a quantization error of a lower layer, in an upper layer.

Patent Literature 1 discloses a layer encoding method in which a quantization error of a lower layer is encoded in an upper layer, and a method for encoding a wider frequency band from a lower layer toward an upper layer using conversion of the sampling frequency.

Here, a scalable codec generally employs a configuration in which a plurality of enhancement layers are prepared above a core codec, and encoding distortion in a lower layer is encoded in an upper layer and transmission is performed. At this time, because there is a correlation between signals input to each layer, performing efficient encoding in an upper layer using encoding information from a lower layer is effective in improving the accuracy of encoding. In this case, the decoder performs decoding in an upper layer using encoding information of a lower layer.

Patent Literature 2 discloses a method of using various encoding information of a lower layer in each layer that employs CELP as a fundamental scheme. Further, Patent Literature 2 discloses a scalable codec with characteristics of employing a multi-stage type in which there are two layers of a core layer and an enhancement layer and a difference signal is encoded in the enhancement layer, and being a frequency scalable codec in which a frequency band of speech changes. In the encoding apparatus of Patent Literature 2, layer information of a lower layer transmitted from block 15 to block 17 considerably contributes the performance. With this information, the enhancement encoder can perform more accurate encoding.

Further, because encoding algorithms have progressed year after year, there is a possibility that codecs having better encoding accuracy will be developed one after another, and there is also a possibility that, from a viewpoint of development of business plans, needs for using reasonable codecs arise.

### CITATION LIST

### Patent Literature

PTL 1
Japanese Patent Application Laid-Open No. 8-263096
PTL 2
Japanese Patent Application Laid-Open No. 2006-72026

### SUMMARY OF INVENTION

### Technical Problem

However, conventional apparatuses have a problem that, when a core encoder and a core decoder in each layer are replaced, because an enhancement encoder is developed based on layer information of a lower layer to be received from the core encoder before replacement, it becomes impossible to perform encoding in the enhancement encoder.

In view of the above, it is therefore an object of the present invention to provide a speech encoding apparatus, a speech decoding apparatus, a speech encoding method, and a speech decoding method that can perform encoding in an enhancement encoder and use a suitable codec each time, even when a core encoder and a core decoder in each layer are replaced by a different core encoder and core decoder, respectively, so that it is possible to perform accurate encoding and decoding.

### Solution to Problem

A speech encoding apparatus according to the present invention employs a configuration to encode a speech signal on a layer basis, using layer information of a lower layer in an upper layer, the apparatus comprising: a first encoding section that generates a code by encoding the speech signal; a decoding section that generates a decoded signal by decoding the code; a detection section that detects a residual of encoding between the speech signal and the decoded signal; an analysis section that receives as input the decoded signal and generates the layer information of the lower layer by performing analysis processing and correction processing; and a second encoding section that encodes the residual of encoding between the speech signal and the layer information of the lower layer.

A speech decoding apparatus according to the present invention employs a configuration to receive as input encoding information generated by encoding a speech signal on a layer basis using layer information at an encoding side of a lower layer, in an upper layer, in a speech encoding apparatus, and encode the encoding information, the speech decoding apparatus comprising: a first decoding section that generates a first decoded signal by decoding a code related to the lower layer out of the encoding information; an analysis section that receives as input the first decoded signal, and generates layer information at a decoding side of the lower layer by performing analysis processing and correction processing; and a second decoding section that generates a second decoded signal by decoding a code related to the upper layer out of the encoding information, using the layer information at the decoding side of the lower layer.

A speech encoding method according to the present invention employs a configuration to encode a speech signal on a layer basis, using layer information of a lower layer, in an upper layer, the method comprising steps of: generating a code by encoding the speech signal; generating a decoded signal by decoding the code; detecting a residual of encoding between the speech signal and the decoded signal; generating the layer information of the lower layer by performing analysis processing and correction processing on the decoded signal; and encoding the residual of encoding using the speech signal and the layer information of the lower layer.

The speech decoding method according to the present invention employs a configuration to decode encoding information generated by encoding a speech signal on a layer basis using layer information at an encoding side of a lower layer, in an upper layer, in a speech encoding apparatus, the method comprising steps of: generating a first decoded signal by decoding a code related to the lower layer out of the encoding information; generating layer information at a decoding side of the lower layer by performing analysis processing and correction processing on the first decoded signal; and generating a second decoded signal by decoding a code related to the upper layer out of the encoding information, using the layer information at the decoding side of the lower layer.

### Advantageous Effects of Invention

According to the present invention, even when a core encoder and a core decoder in each layer are replaced by a different core encoder and core decoder, respectively, it is possible to perform encoding in an enhancement encoder and use a suitable codec each time, so that it is possible to perform accurate encoding and decoding.

### BRIEF DESCRIPTION OF DRAWINGS

FIG. 1 is a block diagram showing a configuration of a speech encoding apparatus according to Embodiment 1 of the present invention;

FIG. 2 is a block diagram showing a configuration of a supplemental analysis section according to Embodiment 1 of the present invention;

FIG. 3 is a block diagram showing a configuration of a speech decoding apparatus according to Embodiment 1 of the present invention;

FIG. 4 shows an analysis window using a lookahead period;

FIG. 5 shows an analysis window according to Embodiment 1 of the present invention;

FIG. 6 is a block diagram showing a configuration of the core encoder of Patent Literature 2; and

FIG. 7 is a block diagram showing a configuration of a supplemental analysis section according to Embodiment 2 of the present invention.

### DESCRIPTION OF EMBODIMENTS

Now embodiments of the present invention will be described in detail with reference to the accompanying drawings.

### Embodiment 1

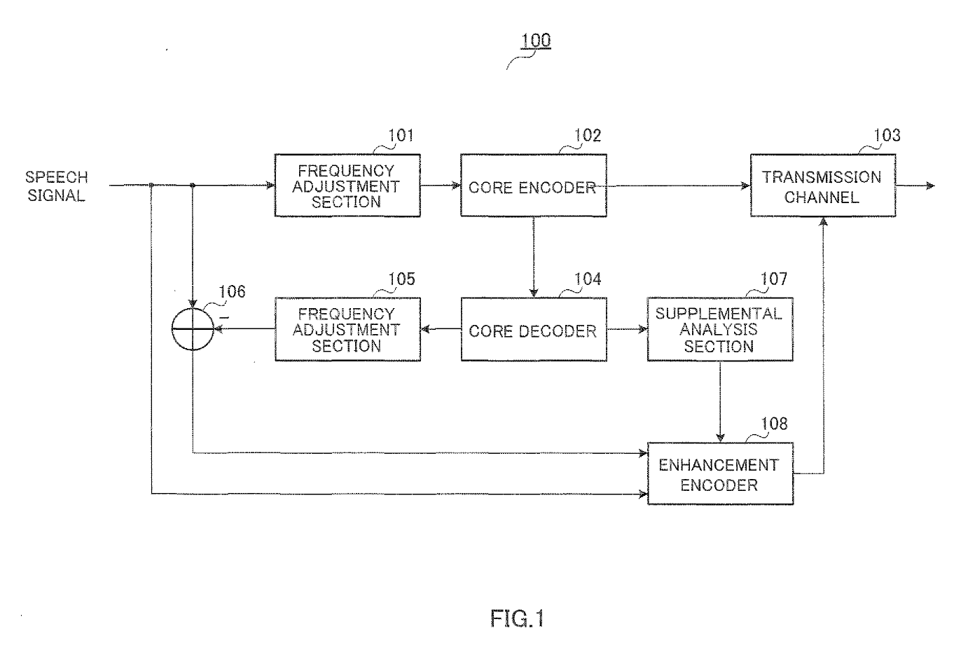

FIG. 1 is a block diagram showing a configuration of speech encoding apparatus 100 according to Embodiment 1 of the present invention.

Speech encoding apparatus 100 is configured mainly with frequency adjustment section 101, core encoder 102, core decoder 104, frequency adjustment section 105, addition section 106, supplemental analysis section 107, and enhancement encoder 108. Each configuration is described in detail below.

Frequency adjustment section 101 performs down-sampling on an input speech signal, and outputs the obtained speech signal (narrow-band speech signal) to core encoder 102. There are various ways of down sampling, one example being a method of performing decimation by passing a signal through a low-pass filter. For example, when an input speech of 16 kHz sampling is converted into an input speech of 8 kHz sampling, a low-pass filter is applied so that a frequency component of equal to or greater than 4 KHz (Nyquist frequency of 8 kHz sampling) is made extremely small. Then, frequency adjustment section 101 then picks up every other signal, which means that one out of two is decimated, and stores those signals in a memory, so that it is possible to obtain a signal of 8 kHz sampling.

Core encoder 102, together with core decoder 104 (described later), can be replaced by a different core encoder and core decoder, respectively, if necessary, and encodes the speech signal input from frequency adjustment section 101 and outputs the obtained code to transmission channel 103 and core decoder 104.

Transmission channel 103 transmits the code obtained in core encoder 102 and a code obtained in enhancement encoder 108 to a speech decoding apparatus (described later).

Core decoder 104, together with core encoder 102, can be replaced, if necessary, and obtains a decoded signal by performing decoding using the code input from core encoder 102. Then, core decoder 104 outputs the obtained decoded signal to frequency adjustment section 105 and supplemental analysis section 107.

Frequency adjustment section 105 performs up-sampling on the decoded signal input from core decoder 104 up to the sampling rate of a speech signal to be input to frequency adjustment section 101, and outputs the signal to addition section 106. There are various up-sampling methods, one example being a method of inserting “0” between the samples to increase the number of samples, adjusting a frequency component by a low-pass filter, and then adjusting power.

Addition section 106 obtains residual of encoding by reversing the polarity of the decoded signal input from frequency adjustment section 105 and adding the decoded signal with the reversed polarity to the speech signal to be input to frequency adjustment section 101. That is, addition section 106 subtracts the decoded signal from the speech signal to be input to frequency adjustment section 101. Then, addition section 106 outputs the residual of encoding obtained by this processing to enhancement encoder 108.

Supplemental analysis section 107 performs analysis on the decoded speech signal input from core decoder 104, and obtains layer information of a lower layer. Then, supplemental analysis section 107 outputs the obtained layer information of the lower layer to enhancement encoder 108. Here, layer information of a lower layer is a decoded linear prediction coefficient (LPC) parameter that is obtained by encoding an LPC parameter obtained by LPC analysis and further decoding the encoded LPC parameter. The decoded LPC parameter shows a general shape of a low frequency spectrum of a speech signal, and is a parameter that is effective for predicting a spectrum remaining in the low frequency spectrum in enhancement encoder 108. However, if encoding and decoding is actually performed, the amount of calculation becomes large and it is necessary to transmit codes, causing increase of cost. Therefore, according to the present embodiment, supplemental analysis section 107 outputs the LPC parameter obtained by performing LPC analysis on the decoded speech signal obtained by core decoder 104, as a parameter approximate to the decoded LPC parameter. Details of the configuration of supplemental analysis section 107 will be described later.

Enhancement encoder 108 receives as input the speech signal input to speech encoding apparatus 100, the residual of encoding obtained in addition section 106, and the layer information of the lower layer obtained in supplemental analysis section 107. Then, enhancement encoder 108 performs efficient encoding on the residual of encoding using information obtained from the speech signal and the layer information of the lower layer, and outputs the obtained code to transmission channel 103.

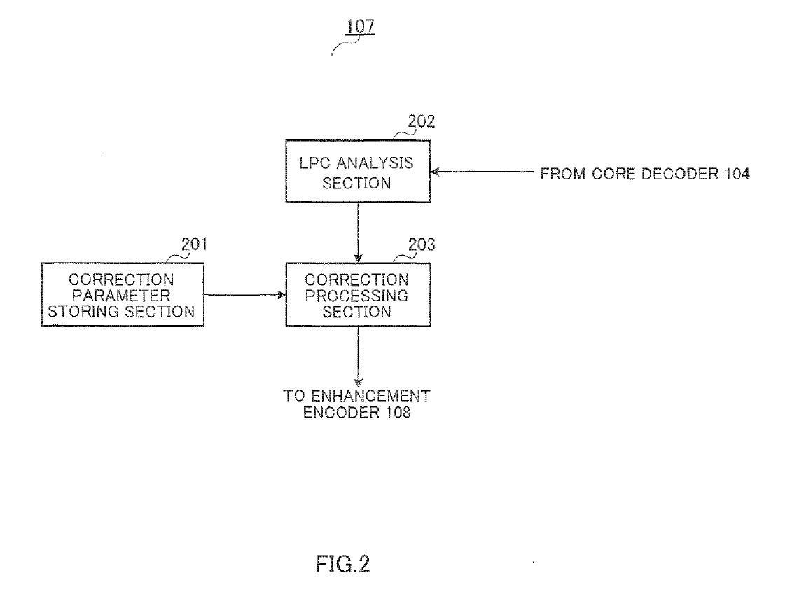

Next, a configuration of supplemental analysis section 107 will be described with reference to FIG. 2. FIG. 2 is a block diagram showing the configuration of supplemental analysis section 107. In the explanation of FIG. 2, layer information of a lower layer is set as an LPC parameter.

Supplemental analysis section 107 is configured mainly with correction parameter storing section 201, LPC analysis section 202, and correction processing section 203.

Correction parameter storing section 201 stores a parameter for correction. A method of setting a correction parameter will be described later.

LPC analysis section 202 performs LPC analysis on the decoded speech signal input from core decoder 104 to obtain an LPC parameter. Then, LPC analysis section 202 outputs the LCP parameter to correction processing section 203.

Correction processing section 203 reads the correction parameter stored in correction parameter storing section 201, and corrects the LPC parameter input from LPC analysis section 202, using the read parameter. Then, correction processing section 203 outputs the corrected LPC parameter to enhancement encoder 108, as a decoded LPC parameter.

The configuration of speech encoding apparatus 100 has been described above.

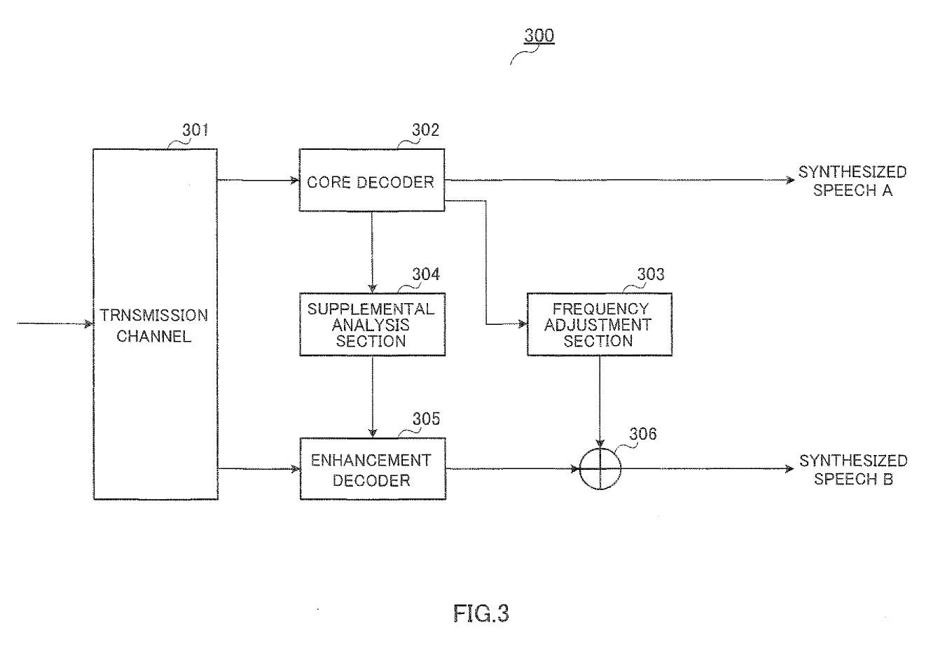

Next, a configuration of speech decoding apparatus 300 will be described with reference to FIG. 3. FIG. 3 is a block diagram showing the configuration of speech decoding apparatus 300.

Speech decoding apparatus 300 is configured mainly with core decoder 302, frequency adjustment section 303, supplemental analysis section 304, enhancement decoder 305, and addition section 306. Each configuration will be described in detail below.

Core decoder 302 decodes a code obtained from transmission channel 301 to obtain synthesized speech A. Further, core decoder 302 outputs synthesized speech A to frequency adjustment section 303 and supplemental analysis section 304. At this time, core decoder 302 outputs synthesized speech A by performing perceptual adjustment.

Frequency adjustment section 303 performs up-sampling on synthesized speech A input from core decoder 302, and outputs synthesized speech A after up-sampling to addition section 306.

Supplemental analysis section 304 performs part of encoding processing on synthesized speech A input from core decoder 302 to obtain layer information of a lower layer, and outputs the obtained layer information of the lower layer to enhancement decoder 305. Here, supplemental analysis section 304 has the same configuration as in FIG. 2.

Enhancement decoder 305 decodes the code obtained from transmission channel 301 using the layer information of the lower layer input from supplemental analysis section 304 to obtain a synthesized speech. Then, enhancement decoder 305 outputs the obtained synthesized speech to addition section 306. Enhancement decoder 305 can obtain synthesized speech having a good quality by performing decoding using the layer information of the lower layer corresponding to speech decoding apparatus 300.

Addition section 306 adds synthesized speech A after up-sampling that is obtained from frequency adjustment section 303 to the synthesized speech obtained from enhancement decoder 305 to determine synthesized speech B, and outputs obtained synthesized speech B.

The configuration of speech decoding apparatus 300 has been described above.

Next, LPC analysis in LPC analysis section 202 will be described below.

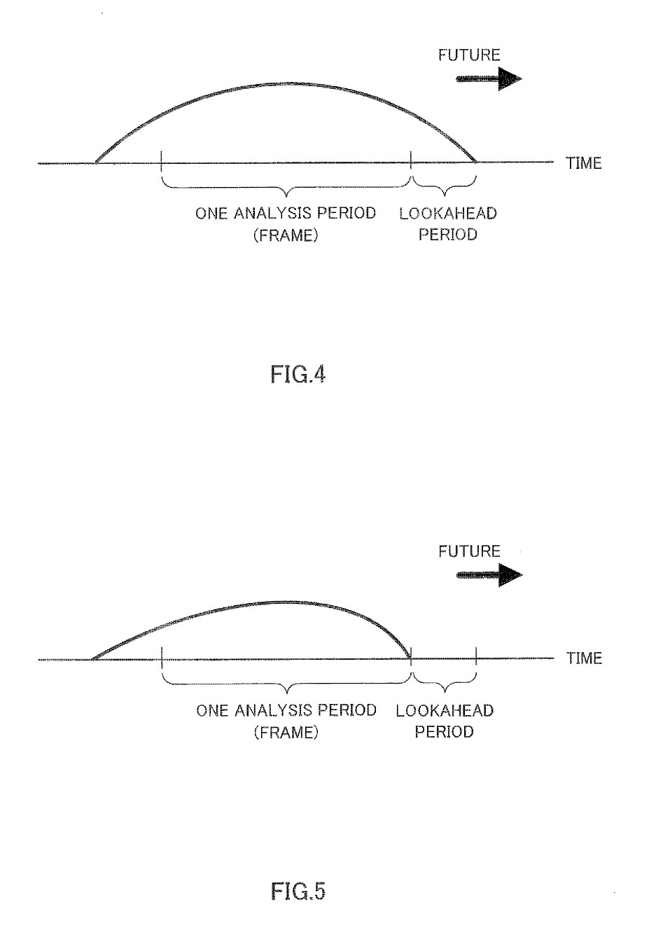

The LPC analysis generally uses an analysis window using a lookahead period (future input speech). FIG. 4 shows an analysis window (window function) using a lookahead period.

The types of the window includes a hamming window, a Hanning window, a sine window, and a Blackman-Harris window. Therefore, using this window, LPC analysis section 202 can perform LPC analysis with the same degree. However, in supplemental analysis section 107, when the analysis window of FIG. 4 is used, delay for a lookahead period occurs. The present embodiment is configured to perform analysis using only the frame period of a decoded speech signal without using a lookahead period.

FIG. 5 shows an example of an analysis window used in the present embodiment. That is, in the present embodiment, as shown in FIG. 5, an asymmetrical window immediately before the lookup period is used. Specifically, by setting a Hanning window in the former part and setting a sine window in the latter part, it is possible to achieve a good performance. The ratio of lengths of each window is determined by performing adjustment with reference to the residual of encoding (distortion of encoding) input to enhancement encoder 108. By setting the window in this way, it is possible to prevent delay from occurring in supplemental analysis section 107. For supplemental analysis section 304, by using the asymmetrical window in the same way as for supplemental analysis section 107, it is possible to prevent delay from occurring.

Next, processing in correction processing section 203 will be described below.

Correction processing section 203 performs correction for two changes: the change of characteristics of the input speech and the decoded speech accompanying encoding and decoding, and the change of characteristics of the analysis window as shown in FIG. 5, so that it is possible to perform accurate encoding in enhancement encoder 108.

With the present embodiment, correction is expressed as the difference of a line spectrum pair (LSP). Procedures are described below.

1) The LPC parameter obtained in LPC analysis section 202 is converted into a LSP.

2) As represented in equation 1, the LSP after correction is determined by adding the correction parameter in correction parameter storing section 201 to the LSP before correction.

(Equation 1)

yᵢ=xᵢ+aᵢ i=0 . . . L [1]

where
yᵢ: LSP after correction
aᵢ: Correction parameter
i: index
L: Degree of LSP
xᵢ: LSP before correction (LSP obtained from a parameter from LPC analysis section 202)

3) Correction is performed so that the relationship of the ascending order of the LSP is maintained.

4) The LSP is returned to a LPC parameter by performing inverse transformation.

The above-described LSP transformation and correction processing for maintaining the relationship of the ascending order are common processing disclosed in most of the textbooks and specifications that describes the algorithm of speech codec based on the CELP scheme, and explanations will be omitted.

Next, a method of setting a correction parameter to be stored in correction parameter storing section 201 will be described below.

The correction parameter is a parameter that depends on core encoder 102 and core decoder 104, and is determined by learning after core encoder 102 and core decoder 104 are mounted.

First, speech data for learning a correction parameter (this is arbitrary, but it is preferable to cover all variations of spectra) is input to speech encoding apparatus 100, as a speech signal. Then, a parameter that is obtained by transforming the LPC parameter obtained by analysis in the LPC analysis section of core encoder 102 into an LSP (hereinafter referred to as “parameter A”) is collected. Further, an LSP that is obtained by analyzing the decoded speech signal obtained through core encoder 102 and core decoder 104 in LPC analysis section 202 of supplemental analysis section 107 (hereinafter referred to as “parameter B”) is collected. These processes are performed for many pieces of speech data for learning a correction parameter to collect parameters A and B. Then, when collection is finished, all parameters are used to determine parameter A and parameter B for minimizing the cost function in equation 2.

$$\begin{matrix}( Equation 2 ) & \\ E = {\sum }_{n}^{N} {\sum }_{i}^{L} {( {A}_{i}^{n} - {B}_{i}^{n} - {a}_{i} )}^{2} & [ 2 ]\end{matrix}$$

where
E: Cost function
N: Total number of pieces of speech data for learning a correction parameter
n: Sample number
Aᵢⁿ: Parameter A
Bᵢⁿ: Parameter B

Further, using parameter A and parameter B that are determined by equation 2, a correction parameter is determined by equation 3.

$$\begin{matrix}( Equation 3 ) & \\ {a}_{i} = {\sum }_{n}^{N} ( {A}_{i}^{n} - {B}_{i}^{n} ) / N & [ 3 ]\end{matrix}$$

Then, the correction parameter determined by equation 3 is stored in correction parameter storing section 201 of supplemental analysis section 107 and a correction parameter storing section (not shown) of supplemental analysis section 304.

In the above-described setting method, because learning is performed after a codec for replacement is decided, it is not possible to perform speech communication immediately after replacement. If it is possible to employ, for example, a method in which a parameter is predetermined per expected codec and is prepared together with the codec, and contents of correction parameter storing section 201 are rewritten at the time of replacement, it is possible to replace codecs more conveniently.

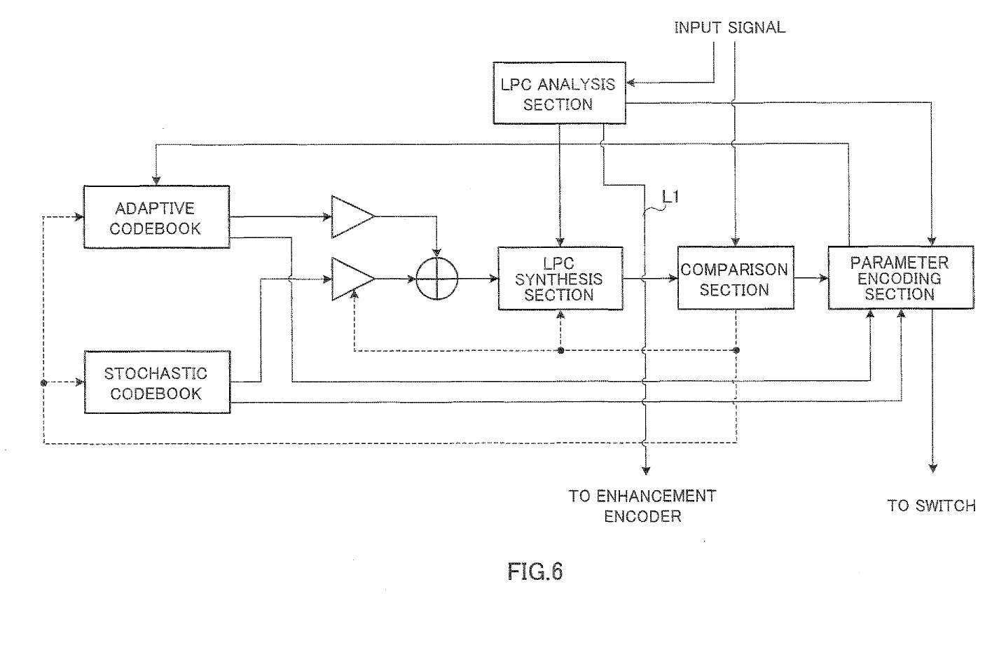

Next, the reason supplemental analysis sections 107 and 304 employ the configuration of FIG. 2 will be described with reference to FIG. 6.

FIG. 6 is a block diagram showing a configuration of the core encoder described in Patent Literature 2. Each configuration of the core encoder of FIG. 6 is described in Patent Literature 2, and overlapping explanations will be omitted.

In FIG. 6, signal line L1, which connects the LPC analysis section that performs LPC analysis and performs quantization and dequantization to the enhancement encoder, transmits the layer information of a lower layer according to the present embodiment.

Therefore, supplemental analysis sections 107 and 304 can employ the same configuration as the core encoder shown in FIG. 6. However, because only a LPC parameter is layer information of a lower layer, it is not necessary to use most blocks in the core encoder of FIG. 6, and supplemental analysis sections 107 and 304 needs to employ only the configuration of FIG. 2.

LPC analysis section 202 of FIG. 2 performs only analysis, among the functions of analysis, encoding, and decoding of the LPC analysis section of FIG. 6. A signal input from core decoder 104 to supplemental analysis section 107 and a signal input from core decoder 302 to supplemental analysis section 304 are decoded signals, and this is the same as in the encoding side and the decoding side, so that it is possible to obtain an equivalent of the LPC parameter by performing only analysis.

As described above, according to the present embodiment, even when a core encoder and a core decoder in a lower layer are replaced by another core encoder and core decoder, it is possible to obtain the same layer information of a lower layer as the layer information before replacement. As a result of this, even when a core encoder and a core decoder in each layer are replaced, it is possible to perform encoding in an enhancement encoder and use a suitable codec each time, so that it is possible to perform accurate encoding and decoding. Further, according to the present embodiment, because analysis is performed by setting a window not containing a lookahead period, it is possible to suppress delay accompanying analysis. Further, according to the present embodiment, correction is performed on the change of characteristics of the input speech and the decoded speech accompanying encoding and decoding, and the change of characteristics of the analysis window, by using a correction parameter. As a result of this, it is possible to bring the decoded LPC parameter statistically closer to the parameter to be obtained by performing analysis on an input speech signal, making it possible to perform accurate encoding.

### Embodiment 2

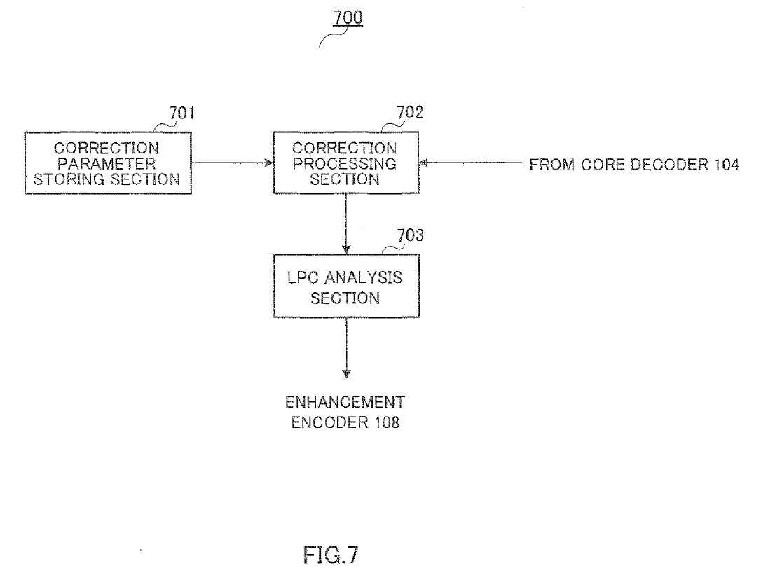

FIG. 7 is a block diagram showing a configuration of supplemental analysis section 700 according to Embodiment 2 of the present invention. In the present embodiment, the speech encoding apparatus employs the same configuration as in FIG. 1, except that supplemental analysis section 107 is replaced by supplemental analysis section 700, and overlapping explanations will be omitted. Further, in the present embodiment, each configuration apart from supplemental analysis section 700 will be described using the reference numerals in FIG. 1.

Supplemental analysis section 700 is configured mainly with correction parameter storing section 701, correction processing section 702, and LPC analysis section 703.

Correction parameter storing section 701 stores a correction parameter. A method of setting a correction parameter will be described later.

Correction processing section 702 reads a correction parameter stored in correction parameter storing section 701, and corrects the decoded signal input from core decoder 104, using the read correction parameter. Then, correction processing section 702 outputs the decoded signal after correction to LPC analysis section 703.

LPC analysis section 703 performs LPC analysis on the decoded signal input from correction processing section 702 to obtain an LPC parameter. Then, LPC analysis section 703 outputs the LPC parameter to enhancement encoder 108.

In the present embodiment, the speech encoding apparatus employs the same configuration as in FIG. 3, except that supplemental analysis section 304 is replaced by the supplemental analysis section of FIG. 7, and overlapping explanations will be omitted.

Next, processing in correction processing section 702 will be described below.

In the present embodiment, correction by the moving average (MA) filtering is performed. In this case, filtering is performed using the correction parameter stored in correction parameter storing section 701. An example of this will be shown in equation 4.

$$\begin{matrix}( Equation 4 ) & \\ {\hat{s}}_{k} = {\sum }_{j = 0}^{J} {β}_{j} \cdot {s}_{k - j} \\ k = 0 … K & [ 4 ]\end{matrix}$$

where
ŝₖ: Decoded speech signal after correction
βⱼ: Correction coefficient
sₖ₋ⱼ: Input decoded speech signal
k: Index of decoded speech signal
K: Length of decoded speech signal
j: index of correction coefficient
J: Degree of correction coefficient

Then, the decoded speech signal after correction that is obtained by equation 4 is output to LPC analysis section 703.

The difference from correction using the LPC parameter in above Embodiment 1 is that, in the present embodiment, it is not necessary to perform calculation for transformation into the LSP parameter, but instead it is not possible to correct the difference of LPC analysis windows.

Next, the method of setting a correction parameter will be described below.

A correction parameter is determined by learning beforehand after the codec is replaced. The input signal is the same speech data for learning a correction parameter as in Embodiment 1. The difference from Embodiment 1 is that the signal input to core encoder 102 (hereinafter referred to as “signal C”) and the decoded speech signal input to supplemental analysis section 700 (hereinafter referred to as “signal D”) are collected. Using a large number of collected signals, signal C and signal D for minimizing cost function F in equation 5 are obtained. At this time, it is necessary to completely match the phases (timing of sampling) of the two signals.

$$\begin{matrix}( Equation 5 ) & \\ F = {\sum }_{n = 0}^{N} {\sum }_{k = 0}^{K} {\sum }_{j = 0}^{J} {( {C}_{k}^{n} - {β}_{j} \cdot {D}_{k - j}^{n} )}^{2} & [ 5 ]\end{matrix}$$

where
F: Cost function
Cₖⁿ: Signal C
Dₖ₋ⱼⁿ: Signal D

Further, using signal C and signal D that are determined by equation 5, a correction parameter is determined by equation 6.

$$\begin{matrix}( Equation 6 ) & \\ {β}_{j} = {\sum }_{n = 0}^{N} {\sum }_{k = 0}^{K} {C}_{k}^{n} \cdot {D}_{k - j}^{n} / {\sum }_{n = 0}^{N} {\sum }_{k = 0}^{K} {D}_{k - j}^{n} \cdot {D}_{k - j}^{n} & [ 6 ]\end{matrix}$$

Then, the correction parameter determined by equation 6 is stored in correction parameter storing section 701 at the encoder side and the decoder side.

As described above, according to the present embodiment, even when a core encoder and a core decoder in a lower layer are replaced by another core encoder and core decoder, it is possible to obtain the same layer information of a lower layer as the layer information before replacement. As a result of this, even when a core encoder and a core decoder in each layer are replaced, it is possible to perform encoding in an enhancement encoder and use a suitable codec each time, so that it is possible to perform accurate encoding and decoding. Further, according to the present embodiment, because analysis is performed by setting a window not containing a lookahead period, it is possible to suppress delay accompanying analysis. Further, according to the present embodiment, correction is performed on the change of characteristics of the input speech and the decoded speech accompanying encoding and decoding, by using a correction parameter. As a result of this, it is possible to bring the decoded LPC parameter statistically closer to the parameter to be obtained by performing analysis on the input speech signal, making it possible to perform accurate encoding.

Although cases have been described with above Embodiment 1 and Embodiment 2, where correction processing sections 203 and 702 perform correction using addition of an LSP, the present invention is not limited to this, and it is equally possible to use linear addition, multiplication of matrices, or addition of matrices. Further, as a parameter for performing correction, it is equally possible to use LPC parameters such as a LPC spectrum, a partial auto correlation (PARCOR), and an immittance spectral pair (ISP), or autocorrelation function. It is clear that the present invention dose not depend on a correction method or a parameter for performing correction.

Further, although cases have been described with above Embodiment 1 and Embodiment 2, where the MA type filtering is performed in correction processing sections 203 and 702, the present invention is not limited to this, and it is equally possible to employ the infinite impulse response (IIR) type or the auto regressive (AR) type. It is clear that the present invention dose not depend on the shape of a filter.

Further, although eases have been described with above Embodiment 1 and Embodiment 2, where correction processing sections 203 and 702 performs filtering, the present invention is not limited to this, and it is equally possible to employ addition of amplitudes or addition of gains. The reason is that the present invention does not depend on a method of processing correction.

Further, although cases have been described with above Embodiment 1 and Embodiment 2, where a scalable codec in which a core layer is replaced is used, the present invention is not limited to this, and it is equally possible to add a switch and a conventional codec to the configuration. At this time, it is possible to switch the conventional codec and a replaced codec by a switch.

Further, although cases have been described with above Embodiment 1 and Embodiment 2, where the decoded LPC parameter is used as encoding information, the present invention is not limited to this, and it is clear that the present invention can be realized using other parameters. Examples include a full-band power or a band power that can be determined with a relatively small amount of calculation from input speech, or a period or a gain showing the degree of periodicity that can be determined by pitch analysis. However, it is obvious that it is difficult to use parameters that can be obtained by operating the CELP encoder of FIG. 6 until the end, such as the gain of a stochastic codebook, in view of the large amount of calculation.

Further, although cases have been described with above Embodiment 1 and Embodiment 2, where the encoding scheme for encoding a time-sequence signal as is such as a CELP, is used as a core encoder, the present invention is not limited to this, and it is equally possible to use conversion encoding such as spectrum encoding by modified discrete cosine transform (MDCT) and waveform coding such as adaptive differential pulse code modulation (ADPCM). Further, by this means, it is clear that, according to the present invention, any codecs can be used as a new codec for replacement. In spectrum encoding, when it is desired to pass input in the form of spectrum to the enhancement section, because each input of supplemental analysis sections 107 and 304 is spectrum, it is possible to change the input system to support that form. It is clear that the present invention does not depend on the encoding schemes of the original codec and the codec for replacement.

Further, although cases have been described with above Embodiment 1 and Embodiment 2, where the number of layers of two is used for easier explanation, the present invention is not limited to this, and it is equally possible to use a plurality of layers of equal to or greater than 3, as is the case with the number of layers used for current standardized scalable codecs, scalable codecs being under standardization, or scalable codecs in practical use. For example, ITU-T-standard G.729.1 employs the number of layers of as many as 12. In this case as well, it is clear that the present invention is effective. The reason is that the present invention does not depend on the number of layers.

Further, although cases have been described with above Embodiment 1 and Embodiment 2, where a core codec is replaced, the present invention is not limited to this, and it is clear that the present invention can be applied to replacement of an enhancement layer. When encoding information of an enhancement layer is used in a further upper layer, by using a supplemental codec configured with part of the enhancement layer before a decoded signal of the replaced layer is replaced, it is possible to perform replacement in the same way as the present invention.

Further, although cases have been described with above Embodiment 1 and Embodiment 2, where the frequency scalable codec is used, the present invention is not limited to this, and the present invention is effective even when the frequency does not change. The reason is that the present invention does not depend on the presence or absence of a frequency adjustment section.

Further, descriptions of above Embodiment 1 and Embodiment 2 are examples of a preferred embodiment of the present invention, and the present invention is not limited to these. The present invention can be applied to any system as long as the system has an encoding apparatus.

Further, the speech encoding apparatus and the speech decoding apparatus described in above Embodiment 1 and Embodiment 2 can be mounted in a communication terminal apparatus and a base station apparatus in a mobile communication system. By this means, it is possible to provide a communication terminal apparatus, a base station apparatus, and a mobile communication system having the same effects as in the above embodiments.

Also, although cases have been described with above Embodiment 1 and Embodiment 2 as examples where the present invention is configured by hardware, the present invention can also be realized by software. For example, it is possible to implement the same functions as in, for example, the speech encoding apparatus according to the present invention by describing algorithms according to the present invention using the programming language, and executing this program with an information processing section by storing in memory.

Each function block employed in the description of above Embodiment 1 and Embodiment 2 may typically be implemented as an LSI constituted by an integrated circuit. These may be individual chips or partially or totally contained on a single chip. “LSI” is adopted here, but this may also be referred to as “IC,” “system LSI,” “super LSI,” or “ultra LSI” depending on differing extents of integration.

Further, the method of circuit integration is not limited to LSI's, and implementation using dedicated circuitry or general purpose processors is also possible. After LSI manufacture, utilization of a programmable FPGA (Field Programmable Gate Array) or a reconfigurable processor where connections and settings of circuit cells within an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosure of Japanese Patent Application No. 2009-60791, filed on Mar. 13, 2009, including the specification, drawings and abstract, is incorporated herein by reference in its entirety.

### INDUSTRIAL APPLICABILITY

A speech encoding apparatus, a speech decoding apparatus, a speech encoding method, and a speech decoding method are suitable for, in particular, a scalable codec having a multi-layer structure.

1. A speech encoding apparatus that encodes a speech signal on a layer basis, using layer information of a lower layer in an upper layer, the apparatus comprising:
a first encoding section that generates a code by encoding the speech signal;
a decoding section that generates a decoded signal by decoding the code;
a detection section that detects a residual of encoding between the speech signal and the decoded signal;
an analysis section that receives as input the decoded signal and generates the layer information of the lower layer by performing analysis processing and correction processing; and
a second encoding section that encodes the residual of encoding between the speech signal and the layer information of the lower layer.

2. The speech encoding apparatus according to claim 1, wherein the analysis section performs the analysis processing using a window function not containing a lookahead period.

3. The speech encoding apparatus according to claim 1, wherein the analysis section generates a parameter related to the lower layer by performing the analysis processing on the decoded signal, and generates the layer information of the lower layer by performing the correction processing on the parameter related to the lower layer based on a change of characteristics from the speech signal to the decoded signal.

4. The speech encoding apparatus according to claim 1, wherein the analysis section generates a corrected decoded signal by performing the correction processing on the decoded signal based on a change of characteristics from the speech signal to the decoded signal, and generates the layer information of the lower layer by performing the analysis processing on the corrected decoded signal.

5. A speech decoding apparatus that receives as input encoding information generated by encoding a speech signal on a layer basis using layer information at an encoding side of a lower layer, in an upper layer, in a speech encoding apparatus, and encodes the encoding information, the speech decoding apparatus comprising:
a first decoding section that generates a first decoded signal by decoding a code related to the lower layer out of the encoding information;
an analysis section that receives as input the first decoded signal, and generates layer information at a decoding side of the lower layer by performing analysis processing and correction processing; and
a second decoding section that generates a second decoded signal by decoding a code related to the upper layer out of the encoding information, using the layer information at the decoding side of the lower layer.

6. A speech encoding method that encodes a speech signal on a layer basis, using layer information of a lower layer, in an upper layer, the method comprising steps of:
generating a code by encoding the speech signal;
generating a decoded signal by decoding the code;
detecting a residual of encoding between the speech signal and the decoded signal;
generating the layer information of the lower layer by performing analysis processing and correction processing on the decoded signal; and
encoding the residual of encoding using the speech signal and the layer information of the lower layer.

7. A speech decoding method that decodes encoding information generated by encoding a speech signal on a layer basis using layer information at an encoding side of a lower layer, in an upper layer, in a speech encoding apparatus, the method comprising steps of:
generating a first decoded signal by decoding a code related to the lower layer out of the encoding information;
generating layer information at a decoding side of the lower layer by performing analysis processing and correction processing on the first decoded signal; and
generating a second decoded signal by decoding a code related to the upper layer out of the encoding information, using the layer information at the decoding side of the lower layer.
